(19) United States
(12) Patent Application Publication
(10) Pub. No.: US 2008/0235188 A1
(43) Pub. Date: Sep. 25, 2008

(54) Universal media guide

(76) Inventor: John Kelly King, Asheville, NC (US)

Correspondence Address: Merchant & Gould P.C., P.O. Box 2903, Minneapolis, MN, 55402-0903, US

(21) Appl. No.: 11/725,921

(22) Filed: Mar. 20, 2007

(51) Int. Cl. G06F 17/30

(52) U.S. Cl. 707/3; 707/E17.014

(57) ABSTRACT

A universal media guide may be provided. A first menu may be provided configured to indicate a plurality of content programs. In response to the provided first menu, a first input may be received indicating the selection of the one of the plurality of content programs. Then, in response to a first input, a second menu may be provided configured to indicate a plurality of topics associated with the selected one of a plurality of content programs. Next, in response to the provided second menu, a second input may be received indicating a selection of one of the plurality of topics. A search may then be performed corresponding to the selected one of the plurality of topics. A search result may then be provided corresponding to the performed search. The search result may comprise a plurality of options corresponding to content associated with the selected one of the plurality of topics.

### BACKGROUND

An electronic program guide (EPG) is an on-screen guide to scheduled broadcast television programs, allowing a user to navigate, select, and discover content by time, title, channel, genre, etc. The viewer may use a remote control device to interact with the EPG.

EPG technology is based upon broadcasting data to an application usually residing within middleware in a set-top box that connects to a television set and enables an EPG application to be displayed. The EPG technology is predominant in the digital television and radio world, but equally EPGs exist that rely upon analogue technology (using the VBI—or vertical blanking interval). These signals may arrive via cable TV, satellite TV, cable radio, satellite radio, or via over-the-air terrestrial broadcast stations.

By navigating through the EPG on a receiving device, the user can see more information about a current program and about future programs. When EPGs are connected to digital video recorders (DVRs), they enable the user to plan viewing and record broadcast programs to a hard disk for later viewing.

### SUMMARY

Consistent with embodiments of the present invention, systems and methods are disclosed for providing a universal media guide. A universal media guide may be provided. A first menu may be provided configured to indicate a plurality of content programs. In response to the provided first menu, a first input may be received indicating the selection of the one of the plurality of content programs. Then, in response to a first input, a second menu may be provided configured to indicate a plurality of topics associated with the selected one of a plurality of content programs. Next, in response to the provided second menu, a second input may be received indicating a selection of one of the plurality of topics. A search may then be performed corresponding to the selected one of the plurality of topics. A search result may then be provided corresponding to the performed search. The search result may comprise a plurality of options corresponding to content associated with the selected one of the plurality of topics.

Both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an operating environment including a media guide processor;

FIG. 2 is a block diagram of the media guide processor; and

FIG. 3 is a flow chart of a method for providing a universal media guide.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention may provide a universal media guide. While watching television, for example, a user may be provided a first menu indicating a plurality of programs that may be viewed on the television. The first menu may be provided on the television or on any other device. The user may provide, in response to the first menu, a first input that may indicate the user's selection of one of the plurality of content programs (e.g. a broadcast television program). Then, in response to a first input, a second menu may be provided to the user indicating a plurality of topics associated with the selected content program. For example, the topics may comprise subject areas referenced during the selected content program as described in more detail below.

Next, the user may provide a second input indicating a selection of one of the plurality of topics from the second menu. A search may then be performed corresponding to the selected topic. Consequently, a search result may then be provided to the user corresponding to the performed search. The search result may comprise a plurality of options corresponding to content associated with the selected one of the plurality of topics. For example, the options may comprise information regarding how content associated with the selected topic is to be obtained as described in more detail below.

Embodiments consistent with the invention may comprise a system for providing a universal media guide. The system may comprise a memory storage and a processing unit coupled to the memory storage. The processing unit may be operative to provide a first menu configured to indicate a plurality of content programs and to receive, in response to the provided first menu, a first input indicating the selection of the one of the plurality of content programs. The processing unit may be operative to provide, in response to a first input, a second menu configured to indicate a plurality of topics associated with the selected one of a plurality of content programs and to receive, in response to the provided second menu, a second input indicating a selection of one of the plurality of topics. In addition, the processing unit may be operative to perform a search corresponding to the selected one of the plurality of topics and to provide a search result corresponding to the performed search. The search result may comprise a plurality of options corresponding to content associated with the selected one of the plurality of topics.

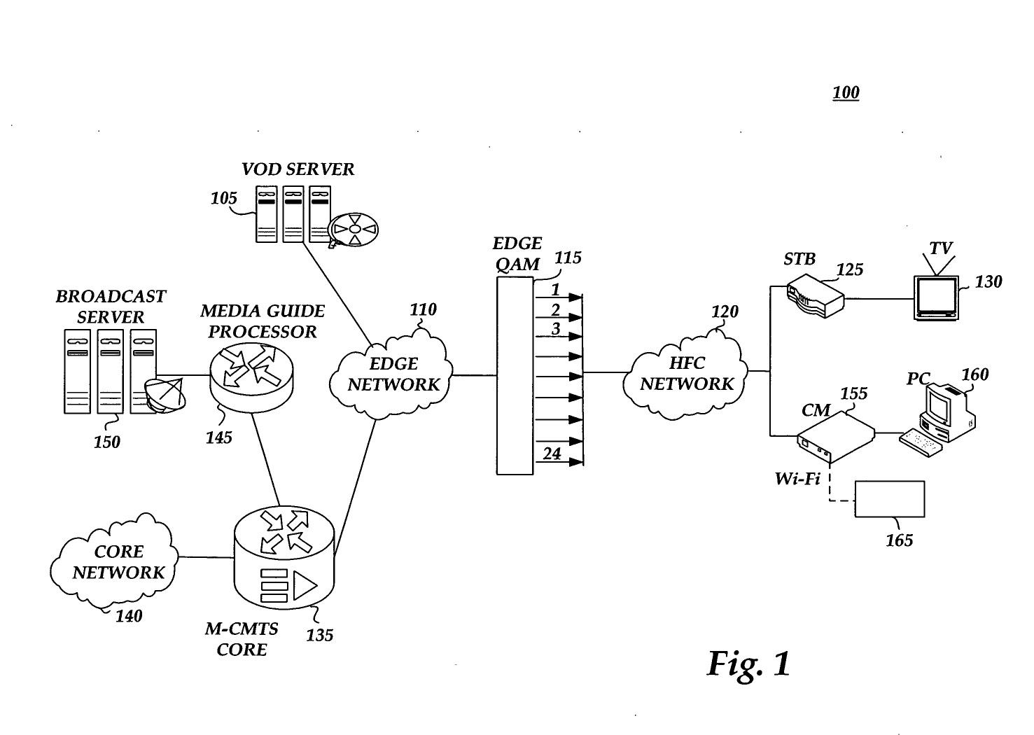

Consistent with an embodiment of the present invention, the aforementioned memory, processing unit, and other components may be implemented in a content delivery system, such as an exemplary content delivery system 100 of FIG. 1. Any suitable combination of hardware, software, and/or firmware may be used to implement the memory, processing unit, or other components. By way of example, the memory, processing unit, or other components may be implemented with any of a video on demand (VOD) server 105, a set top box (STB) 125, a media guide processor 145, a broadcast server 150, or a cable modem (CM) 155 in combination with system 100. The aforementioned system and processors are exemplary and other systems and processors may comprise the aforementioned memory, processing unit, or other components, consistent with embodiments of the present invention.

By way of a non-limiting example, FIG. 1 illustrates system 100 in which embodiments of the invention may be implemented. As illustrated in FIG. 1, system 100 may include VOD server 105, an edge network 110, an edge quadrature amplitude modulation (QAM) device 115, a hybrid fiber-coax (HFC) network 120, STB 125, a television (TV) 130, a modular cable modem termination system (M-CMTS) core 135, a core network 140, media guide processor 145, broadcast server 150, CM 155, a personal computer (PC) 160, and a portable device 165 using wireless fidelity (Wi-Fi), for example. System 100, for example, may generate moving pictures experts group (MPEG) packets over internet protocol (IP) datagrams that can then be received by edge QAM 115.

VOD server 105 may take MPEG compressed video off of a hard disk, format it into MPEG-TS packets inside a user datagram protocol (UDP) packet, and send it into edge network 110. The UDP packets may be received by edge QAM 115, where IP encapsulation may be removed. The MPEG packets may then be forwarded down one QAM channel onto HFC network 120.

HFC network 120 may comprise a communications network (e.g. a cable TV network) that uses a combination of optical fibers and coaxial cable. The fiber in HFC network 120 may provide a high-speed backbone. Coax may be used in HFC network 120 to connect end users to the backbone. Such networks may use, for example, matching data over cable service interface specification (DOCSIS) cable modems at a head end and at a customer premises. Such a configuration may provide bidirectional paths and Internet access.

The MPEG packets may be received, for example, by STB 125 where the video may be removed, decompressed, and sent to TV 130, for example. STB 125 may include all the functionality provided by a cable modem such as CM 155, for example.

M-CMTS core 135 may receive IP datagrams from core network 140. M-CMTS core 135 may then forward these IP datagrams to either a single QAM channel within edge QAM 115 with traditional DOCSIS encapsulation, or may forward the IP datagrams to multiple QAM channels within edge QAM 115 using DOCSIS bonding.

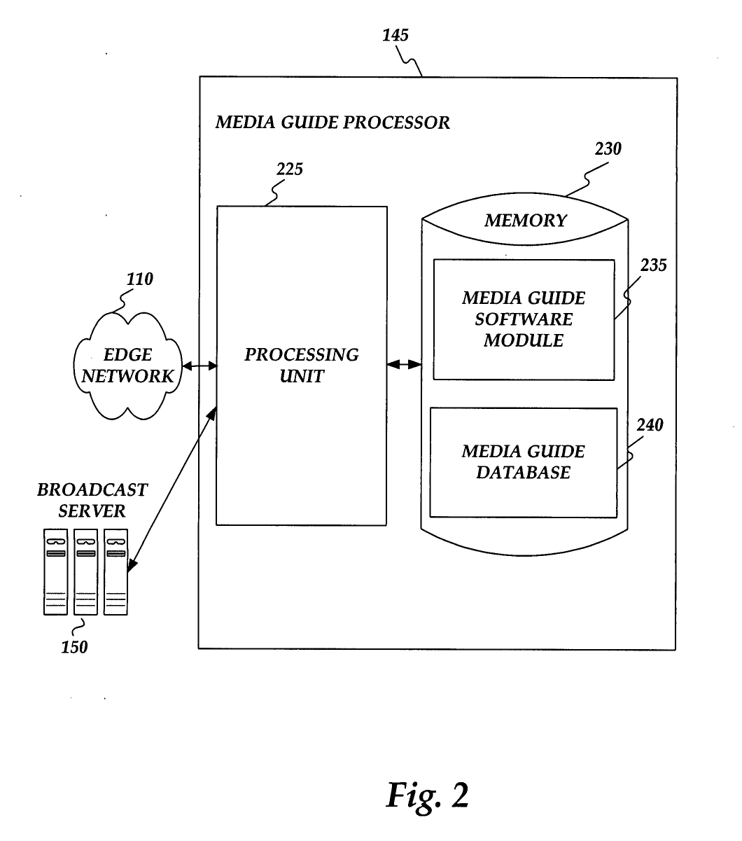

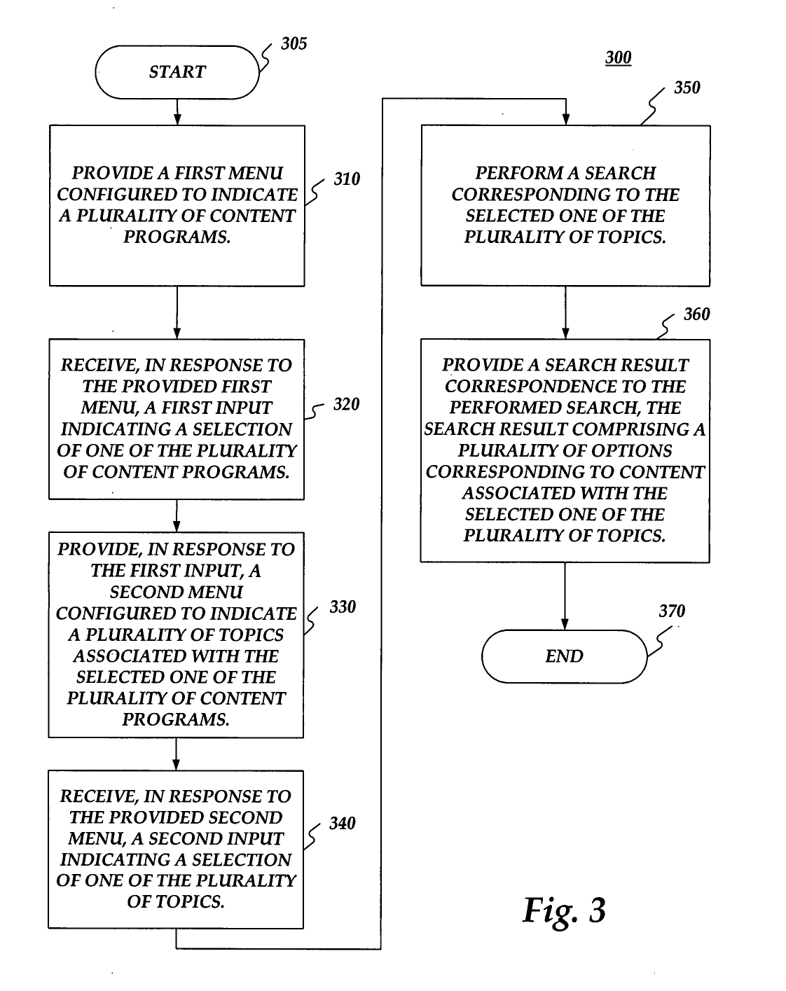

FIG. 2 shows media guide processor 145 of FIG. 1 in more detail. As shown in FIG. 2, media guide processor 145 may include a processing unit 225 and a memory 230. Memory 230 may include a media guide software module 235 and a media guide database 240. While executing on processing unit 225, media guide software module 235 may perform processes for providing a universal media guide, for example, one or more of the stages of method 300 described below with respect to FIG. 3. Furthermore, any combination of software module 235 and database 240 may be executed on or reside in any one or more of the elements as shown in FIG. 1.

Media guide processor 145 (“the processor”) included in system 100 may be implemented using a personal computer, network computer, mainframe, or other similar microcomputer-based workstation. The processor may though comprise any type of computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. The aforementioned systems and devices are exemplary and the processor may comprise other systems or devices.

FIG. 3 is a flow chart setting forth the general stages involved in a method 300 consistent with embodiments of the invention for providing a universal media guide. Method 300 may be implemented using a media guide processor 145 as described in more detail above with respect to FIG. 2. Ways to implement the stages of method 300 will be described in greater detail below. Method 300 may begin at starting block 305 and proceed to stage 310 where media guide processor 145 may provide a first menu. The first menu may be configured to indicate a plurality of content programs. For example, a user may be viewing TV 130, PC 160, or portable device 165. While the user is viewing any of these devices, media guide processor 145 may cause the first menu to be displayed on any of the aforementioned devices. The first menu may indicate a plurality of content programs available from a content service provider to a user. For example, the first menu may indicate, but is not limited to, television programs, video on demand programs, or any other content that the user may view. System 100 may deliver any content to the user and is not limited to analog or digital cable television system programming.

From stage 310, where media guide processor 145 provides the first menu, method 300 may advance to stage 320 where media guide processor 145 may receive, in response to the provided first menu, a first input. The first input may indicate the selection of the one of the plurality of content programs. For example, while viewing the first menu, the user may select content to view.

Once media guide processor 145 receives the first input in stage 320, method 300 may continue to stage 330 where media guide processor 145 may provide, in response to the first input, a second menu. The second menu may be configured to indicate a plurality of topics associated with the selected one of a plurality of content programs. For example, while viewing the selected content program the user may be presented the second menu. The second menu may list, for example, the actors' names that are present in the selected content program. For example, the plurality of topics may comprise subject areas referenced during the selected content program. The subject areas referenced may comprise, but are not limited to, a celebrity name, a host name, an actor's name, an historic figure, a story referenced, a location referenced, or a time period referenced.

After media guide processor 145 provides the second menu in stage 330, method 300 may proceed to stage 340 where media guide processor 145 may receive, in response to the provided second menu, a second input. The second input may indicate a selection of one of the plurality of topics. For example, the user may wish to have more information regarding an actor in the selected content program. Consequently, the user may select (e.g. provide second input), from the second menu, a particular actor that the user may have interest.

Once media guide processor 145 receives the second input in stage 340, method 300 may continue to stage 350 where media guide processor 145 may perform a search corresponding to the selected one of the plurality of topics. For example, media guide processor 145 may maintain in media guide database 240, a data repository containing data relative to all of the topics that media guide processor 145 is capable of presenting. The search corresponding to the selected one of the plurality of topics may extract data from the data repository relative to the selected topic. The search is not limited to extracting data from the data repository and may receive data from other sources. For example, the search may include extracting data available from core network 140 (e.g. the Internet). The data may be extracted from sources in and outside system 100.

After media guide processor 145 performs the search in stage 350, method 300 may proceed to stage 360 where media guide processor 145 may provide a search result corresponding to the performed search. The search result may comprise a plurality of options corresponding to content associated with the selected one of the plurality of topics. For example, the search result may present a plurality of options each comprising information regarding how content associated with the selected topic is to be obtained. The plurality of options may include, but are not limited to: i) linear content related to the selected one of the plurality of topics; ii) video-on-demand (VOD) content related to the selected one of the plurality of topics; iii) information on subscribing to a service providing the VOD content related to the selected one of the plurality of topics; iv) digital video disk (DVD) content related to the selected one of the plurality of topics; v) information on subscribing to a service providing the DVD content related to the selected one of the plurality of topics; vi) movie content related to the selected one of the plurality of topics; vii) information on purchasing tickets for the movie content related to the selected one of the plurality of topics; viii) concert content related to the selected one of the plurality of topics; ix) information on purchasing tickets for the concert content related to the selected one of the plurality of topics; x) compact disk (CD) content related to the selected one of the plurality of topics; xi) information on subscribing to a service providing the CD content related to the selected one of the plurality of topics; xii) digital recording content related to the selected one of the plurality of topics; xiii) information on subscribing to a service providing the digital recording content related to the selected one of the plurality of topics; xiv) book content related to the selected one of the plurality of topics; xv) information on purchasing the book content related to the selected one of the plurality of topics; xvi) news stories related to the selected one of the plurality of topics; and xvii) a biography related to the selected one of the plurality of topics.

As stated above, the user may select from the second menu a particular actor that the user may have interest. Consequently, the performed search may correspond to the topic corresponding to the actor selected from the second menu. As a result, the presented search result may comprise a plurality of options corresponding to content associated with the selected actor. For example, the plurality of options may include links to an album associated with the selected actor, a local concert performed by the selected actor, movies on pay-per-view, video-on-demand, or DVDs associated with the selected actor. In addition, the plurality of options may include links to purchasable movie tickets to a local movie theater showing a movie associated with the selected actor. Moreover, the plurality of options may include links to news or gossip associated with the selected actor. The aforementioned are examples and the topics and options may comprise others. Once media guide processor 145 provides the search result in stage 360, method 300 may then end at stage 370.

An embodiment consistent with the invention may comprise a system for providing a universal media guide. The system may comprise a memory storage and a processing unit coupled to the memory storage. The processing unit may be operative to provide, in response to a first input, a second menu configured to indicate a plurality of topics associated with a selected one of a plurality of content programs. The processing unit may be further operative to receive, in response to the provided second menu, a second input indicating a selection of one of the plurality of topics. In addition, the processing unit may be further operative to perform a search corresponding to the selected one of the plurality of topics. The processing unit may be further operative to provide a search result corresponding to the performed search. The search result may comprise a plurality of options corresponding to content associated with the selected one of the plurality of topics.

Another embodiment consistent with the invention may comprise a system for providing a universal media guide. The system may comprise a memory storage and a processing unit coupled to the memory storage. The processing unit may be operative to provide, in response to a first input, a second menu configured to indicate a plurality of topics associated with a selected one of a plurality of content programs. The processing unit may be further operative to receive, in response to the provided second menu, a second input indicating a selection of one of the plurality of topics. In addition, the processing unit may be operative provide a search result corresponding to a performed search. The search result may comprise a plurality of options corresponding to content associated with the selected one of the plurality of topics.

Yet another embodiment consistent with the invention may comprise a system for providing a universal media guide. The system may comprise a memory storage and a processing unit coupled to the memory storage. The processing unit may be operative to provide a first menu configured to indicate a plurality of content programs and to receive, in response to the provided first menu, a first input indicating the selection of the one of the plurality of content programs. The processing unit may be operative to provide, in response to a first input, a second menu configured to indicate a plurality of topics associated with the selected one of a plurality of content programs and to receive, in response to the provided second menu, a second input indicating a selection of one of the plurality of topics. In addition, the processing unit may be operative to perform a search corresponding to the selected one of the plurality of topics and to provide a search result corresponding to the performed search. The search result may comprise a plurality of options corresponding to content associated with the selected one of the plurality of topics.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a universal media guide, the method comprising:
providing, in response to a first input, a second menu configured to indicate a plurality of topics associated with a selected one of a plurality of content programs;
receiving, in response to the provided second menu, a second input indicating a selection of one of the plurality of topics;
performing a search corresponding to the selected one of the plurality of topics; and
providing a search result corresponding to the performed search, the search result comprising a plurality of options corresponding to content associated with the selected one of the plurality of topics.

2. The method of claim 1, wherein providing, in response to the first input, the second menu configured to indicate the plurality of topics comprises providing the second menu configured to indicate the plurality of topics comprising subject areas referenced during the selected one of the plurality of content programs.

3. The method of claim 1, wherein providing, in response to the first input, the second menu configured to indicate the plurality of topics comprises providing the second menu configured to indicate the plurality of topics comprising at least two of the following subject areas referenced during the selected one of the plurality of content programs: a celebrity name, a host name, an actor's name, an historic figure, a story referenced, a location referenced, and a time period referenced.

4. The method of claim 1, wherein providing the search result corresponding to the performed search, the search result comprising the plurality of options comprises providing the search result corresponding to the performed search, the search result comprising the plurality of options each comprising information regarding how content associated with the selected one of the plurality of topics is to be obtained.

5. The method of claim 1, wherein providing the search result corresponding to the performed search, the search result comprising the plurality of options comprises providing the search result corresponding to the performed search, the search result comprising the plurality of options comprising links to at least two of the following: linear content related to the selected one of the plurality of topics, video-on-demand (VOD) content related to the selected one of the plurality of topics, information on subscribing to a service providing the VOD content related to the selected one of the plurality of topics, digital video disk (DVD) content related to the selected one of the plurality of topics, information on subscribing to a service providing the DVD content related to the selected one of the plurality of topics, movie content related to the selected one of the plurality of topics, information on purchasing tickets for the movie content related to the selected one of the plurality of topics, concert content related to the selected one of the plurality of topics, information on purchasing tickets for the concert content related to the selected one of the plurality of topics, compact disk (CD) content related to the selected one of the plurality of topics, information on subscribing to a service providing the CD content related to the selected one of the plurality of topics, digital recording content related to the selected one of the plurality of topics, information on subscribing to a service providing the digital recording content related to the selected one of the plurality of topics, book content related to the selected one of the plurality of topics, information on purchasing the book content related to the selected one of the plurality of topics, news stories related to the selected one of the plurality of topics, and a biography related to the selected one of the plurality of topics.

6. The method of claim 1, further comprising:
providing a first menu configured to indicate the plurality of content programs; and
receiving, in response to the provided first menu, the first input indicating the selection of the one of the plurality of content programs.

7. The method of claim 6, wherein providing the first menu configured to indicate the plurality of content programs comprises providing the first menu configured to indicate the plurality of content programs available from a content service provider to a user.

8. A system for providing a universal media guide, the system comprising:
a memory storage; and
a processing unit coupled to the memory storage, wherein the processing unit is operative to:
provide, in response to a first input, a second menu configured to indicate a plurality of topics associated with a selected one of a plurality of content programs;
receive, in response to the provided second menu, a second input indicating a selection of one of the plurality of topics; and
provide a search result corresponding to a performed search, the search result comprising a plurality of options corresponding to content associated with the selected one of the plurality of topics.

9. The system of claim 8, wherein the processing unit being operative to provide, in response to the first input, the second menu configured to indicate the plurality of topics comprises the processing unit being operative to provide the second menu configured to indicate the plurality of topics comprising subject areas referenced during the selected one of the plurality of content programs.

10. The system of claim 8, wherein the processing unit being operative to provide, in response to the first input, the second menu configured to indicate the plurality of topics comprises the processing unit being operative to provide the second menu configured to indicate the plurality of topics comprising at least two of the following subject areas referenced during the selected one of the plurality of content programs: a celebrity name, a host name, an actor's name, an historic figure, a story referenced, a location referenced, and a time period referenced.

11. The system of claim 8, wherein the processing unit being operative to provide the search result corresponding to the performed search, the search result comprising the plurality of options comprises the processing unit being operative to provide the search result corresponding to the performed search, the search result comprising the plurality of options each comprising information regarding how content associated with the selected one of the plurality of topics is to be obtained.

12. The system of claim 8, wherein the processing unit being operative to provide the search result corresponding to the performed search, the search result comprising the plurality of options comprises the processing unit being operative to provide the search result corresponding to the performed search, the search result comprising the plurality of options comprising links to at least two of the following: linear content related to the selected one of the plurality of topics, video-on-demand (VOD) content related to the selected one of the plurality of topics, information on subscribing to a service providing the VOD content related to the selected one of the plurality of topics, digital video disk (DVD) content related to the selected one of the plurality of topics, information on subscribing to a service providing the DVD content related to the selected one of the plurality of topics, movie content related to the selected one of the plurality of topics, information on purchasing tickets for the movie content related to the selected one of the plurality of topics, concert content related to the selected one of the plurality of topics, information on purchasing tickets for the concert content related to the selected one of the plurality of topics, compact disk (CD) content related to the selected one of the plurality of topics, information on subscribing to a service providing the CD content related to the selected one of the plurality of topics, digital recording content related to the selected one of the plurality of topics, information on subscribing to a service providing the digital recording content related to the selected one of the plurality of topics, book content related to the selected one of the plurality of topics, information on purchasing the book content related to the selected one of the plurality of topics, news stories related to the selected one of the plurality of topics, and a biography related to the selected one of the plurality of topics.

13. The system of claim 8, further comprising the processing unit being operative to provide:
provide a first menu configured to indicate the plurality of content programs; and
receive, in response to the provided first menu, the first input indicating the selection of the one of the plurality of content programs.

14. The system of claim 13, wherein the processing unit being operative to provide the first menu configured to indicate the plurality of content programs comprises the processing unit being operative to provide the first menu configured to indicate the plurality of content programs available from a content service provider to a user.

15. A computer-readable medium which stores a set of instructions which when executed performs a method for providing a universal media guide, the method executed by the set of instructions comprising:
providing a first menu configured to indicate a plurality of content programs;
receiving, in response to the provided first menu, a first input indicating the selection of the one of the plurality of content programs;
providing, in response to a first input, a second menu configured to indicate a plurality of topics associated with the selected one of a plurality of content programs;
receiving, in response to the provided second menu, a second input indicating a selection of one of the plurality of topics;
performing a search corresponding to the selected one of the plurality of topics; and
providing a search result corresponding to the performed search, the search result comprising a plurality of options corresponding to content associated with the selected one of the plurality of topics.

16. The computer-readable medium of claim 15, wherein providing, in response to the first input, the second menu configured to indicate the plurality of topics comprises providing the second menu configured to indicate the plurality of topics comprising subject areas referenced during the selected one of the plurality of content programs.

17. The computer-readable medium of claim 15, wherein providing, in response to the first input, the second menu configured to indicate the plurality of topics comprises providing the second menu configured to indicate the plurality of topics comprising at least two of the following subject areas referenced during the selected one of the plurality of content programs: a celebrity name, a host name, an actor's name, an historic figure, a story referenced, a location referenced, and a time period referenced.

18. The computer-readable medium of claim 15, wherein providing the search result corresponding to the performed search, the search result comprising the plurality of options comprises providing the search result corresponding to the performed search, the search result comprising the plurality of options each comprising information regarding how content associated with the selected one of the plurality of topics is to be obtained.

19. The computer-readable medium of claim 15, wherein providing the search result corresponding to the performed search, the search result comprising the plurality of options comprises providing the search result corresponding to the performed search, the search result comprising the plurality of options comprising links to at least two of the following: linear content related to the selected one of the plurality of topics, video-on-demand (VOD) content related to the selected one of the plurality of topics, information on subscribing to a service providing the VOD content related to the selected one of the plurality of topics, digital video disk (DVD) content related to the selected one of the plurality of topics, information on subscribing to a service providing the DVD content related to the selected one of the plurality of topics, movie content related to the selected one of the plurality of topics, information on purchasing tickets for the movie content related to the selected one of the plurality of topics, concert content related to the selected one of the plurality of topics, information on purchasing tickets for the concert content related to the selected one of the plurality of topics, compact disk (CD) content related to the selected one of the plurality of topics, information on subscribing to a service providing the CD content related to the selected one of the plurality of topics, digital recording content related to the selected one of the plurality of topics, information on subscribing to a service providing the digital recording content related to the selected one of the plurality of topics, book content related to the selected one of the plurality of topics, information on purchasing the book content related to the selected one of the plurality of topics, news stories related to the selected one of the plurality of topics, and a biography related to the selected one of the plurality of topics.

20. The computer-readable medium of claim 15, wherein providing the first menu configured to indicate the plurality of content programs comprises providing the first menu configured to indicate the plurality of content programs available from a content service provider to a user.
